(19) United States
(12) Patent Application Publication
(10) Pub. No.: US 2004/0119176 A1
(43) Pub. Date: Jun. 24, 2004

(54) Method for manufacturing lenses

(75) Inventors: Erning Xia, Penfield, NY (US); Erik M. Indra, Moorpark, CA (US); William J. Appleton, Rochester, NY (US); Sanjay Rastogi, Rochester, NY (US); Kevin Hall, Rochester, NY (US); Mahendra P. Nandu, Pittsford, NY (US); Dominic V. Ruscio, Webster, NY (US)

Correspondence Address: Bausch & Lomb Incorporated, One Bausch & Lomb Place, Rochester, NY, 14604-2701, US

(73) Assignee: Bausch & Lomb Incorporated, Rochester, NY

(21) Appl. No.: 10/328,364

(22) Filed: Dec. 23, 2002

(51) Int. Cl. B29D 11/00

(52) U.S. Cl. 264/1.32; 264/2.6

(57) ABSTRACT

A method of manufacturing an ophthalmic lens, involves contacting the lens with an aqueous solution comprising a surfactant to remove debris from the lens, prior to inspecting and packaging the lens. The aqueous solution may further comprise a buffering agent and/or sodium chloride. Preferred surfactants include polyoxyethylene-polyoxypropylene block copolymer, nonionic surfactants, such as a poloxamer or a poloxamine. The methods may also be employed for additional biomedical devices, such as ophthalmic implants.

### FIELD OF THE INVENTION

This invention relates to manufacturing methods for ophthalmic lenses such as contact lenses or intraocular lenses. Particularly, this invention provides for removing debris from such lenses with a surfactant-containing composition between manufacturing stages.

### BACKGROUND

Contact lenses are made of various polymeric materials, including rigid gas permeable materials, soft elastomeric materials, and soft hydrogel materials. The majority of contact lenses sold today are made of soft hydrogel materials. Hydrogels are a cross-linked polymeric system that absorbs and retains water, typically 10 to 80 percent by weight, and especially 20 to 70 percent water. Hydrogel lenses are commonly prepared by polymerizing a lens-forming monomer mixture including at least one hydrophilic monomer, such as 2-hydroxyethyl methacrylate, N,N-dimethylacrylamide, N-vinyl-2-pyrrolidone, glycerol methacrylate, and methacrylic acid. In the case of silicone hydrogel lenses, a silicone-containing monomer is copolymerized with the hydrophilic monomers.

Various processes are known for manufacturing contact lenses. One process, referred to as static cast molding, involves casting a mixture of lens-forming monomers in a two-part mold. One mold part includes a molding surface for forming the front lens surface, and the second mold part includes a molding surface for forming the back lens surface. The monomer mixture is polymerized, or cured, while in the two-part mold to form a contact lens. An alternate process, referred to as spincasting, involves casting a lens-forming monomer mixture in a one-piece front mold. This mold is spun in a manner to form the back lens surface, and the monomer mixture is polymerized while the mold is spun. These casting methods permit large-scale manufacturing, including automated or semi-automated processing to reduce operator errors and handling, as well as reduce manufacturing cost.

Following casting of the contact lens, the cast lens is subjected to various downstream processes. In the case of non-silicone hydrogel contact lenses, the lenses are typically extracted with water or an aqueous solution to remove any impurities and to hydrate the lens. Such extraction and hydration processes may be formed as a combined, single operation or as multiple, separate operations. Then, the lens is typically inspected, either manually or with automation, and packaged for sale in a sealed package. In the case of silicone hydrogel contact lenses, the lenses generally require a more rigorous extraction process, employing an organic solvent to remove impurities such as unreacted monomers or oligomers formed as byproducts of the polymerization process. Then, the lenses are subjected to one or more hydration steps where the lens are contacted with water or an aqueous solution, so as to hydrate the lens and replace the organic solvent used in the prior extraction step. Subsequently, the lenses are inspected and packaged.

The present invention recognizes the problem that various debris can accumulate on the contact lens during manufacturing, even for automated or semi-automated manufacturing processes. One prior approach involves manual cleaning of the lenses, where an operator gently rubs the lens to remove debris prior to conducting inspection. However, this process is labor intensive, and thus involves higher manufacturing costs; additionally, the operator may damage the lens. Another prior approach involves avoiding any cleaning of the lens prior to inspection. However, this approach often results in contaminated lenses being discarded as defective, even though the lenses are satisfactory except for being contaminated with debris. Accordingly, yields are reduced, thus contributing to higher manufacturing costs, as contaminated lenses that otherwise have no defects are discarded.

Intraocular lenses may also be cast by polymerizing a lens-forming mixture in a mold. Similar to contact lens manufacture, intraocular lenses are typically inspected and packaged.

In the normal course of wearing contact lenses, wearers are typically instructed to clean their lenses periodically to remove debris from tear film or the environment that may contaminate the lens. For example, U.S. Pat. No. 4,820,352 (Reidhammer et al.) discloses compositions designed for use by contact lens wearers that include various surfactants. Additional examples of compositions designed for use by contact lens wearers are found in U.S. Pat. No. 5,858,937 (Richards et al.). These patents do not address use of the compositions for cleaning contact lenses between manufacturing stages.

The present invention recognizes that it would be advantageous to remove debris from an ophthalmic lens during manufacturing, so as to improve downstream manufacturing stages, reduce manufacturing cost, and improve manufacturing yields. The removal of debris is accomplished without manual rubbing of the lens.

### SUMMARY OF THE INVENTION

This invention relates to a method of manufacturing an ophthalmic lens, comprising sequentially: casting an ophthalmic lens by polymerizing a lens-forming monomer mixture in a mold, and removing the cast lens from the mold; contacting the cast lens with an aqueous solution comprising a surfactant to remove debris from the lens; and inspecting and packaging the lens. The aqueous solution may further comprise a buffering agent and/or sodium chloride. Preferred surfactants include polyoxyethylene-polyoxypropylene block copolymer, nonionic surfactants, such as a poloxamer or a poloxamine. The methods of this invention may also be employed for additional biomedical devices, such as ophthalmic implants, where the device is contacted with the solution prior to inspecting and packaging the device.

### DETAILED DESCRIPTION OF VARIOUS PREFERRED EMBODIMENTS

This invention is applicable to ophthalmic lenses, including contact lenses and intraocular lenses. The lenses may be made of a hydrogel copolymer. Soft hydrogel contact lenses are made of a hydrogel polymeric material, a hydrogel being defined as a cross-linked polymeric system containing water in an equilibrium state. Representative conventional hydrogel contact lens materials are made by polymerizing a monomer mixture comprising at least one hydrophilic monomer, including: (meth)acrylic acids, such as methacrylic acid and acrylic acid; (meth)acrylated alkyl ethers, such as 2-hydroxyethyl methacrylate (HEMA), hydroxyethylacrylate, and glycerol methacrylate; alkyl (meth)acrylamides, such as N,N-dimethylacrylamide (DMA) and N,N-dimethylmethacrylamide; and N-vinyl lactams, such as N-vinylpyrrolidone (NVP). In the case of silicone hydrogels, the monomer mixture from which the copolymer is prepared further includes a silicone-containing monomer, in addition to the hydrophilic monomer. Generally, the monomer mixture will include a crosslinking monomer, i.e., a monomer having at least two polymerizable radicals, such as ethylene glycol dimethacrylate, tetraethylene glycol dimethacrylate, and 2-ethylmethacrylate-vinylcarbonate. Alternately, either the silicone-containing monomer or the hydrophilic monomer may function as a crosslinking agent.

Intraocular lenses may similarly be made of a hydrogel copolymer. Other know classes of materials for intraocular lenses include non-hydrogel silicone materials and hydrophobic acrylic

As mentioned, various processes are known for manufacturing ophthalmic lenses, such as contact lenses and intraocular lenses. Such methods include static cast molding and spincasting. For static cast molding, a mixture of lens-forming monomers is introduced to a two-part mold. One mold part includes a molding surface for forming the front lens surface, and the second mold part includes a molding surface for forming the back lens surface. The monomer mixture is polymerized, or cured, such as by exposing the monomer mixture in the mold to light energy (for example, UV radiation), heat energy, or combinations of light and heat energy. For spincasting, a lens-forming monomer mixture is introduced to a one-piece front mold that is spun in a controlled manner to form the back lens surface, and the monomer mixture is subjected to light and/or heat energy while the mold is spun to cure the lens-forming monomer mixture.

After the lens is cast, it is removed from the mold for subsequent processing, including extraction and/or hydration, inspection and packaging.

Extraction serves to remove impurities from the cast lens. Hydration, in the case of hydrogel lenses, serves to hydrate the lens with water. In the case of non-silicone hydrogel contact lenses, a non-reactive diluent is often added to the lens-forming monomer mixture, and this diluent can be extracted from the cast lens with an aqueous solution. This aqueous solution may also be used as the hydration step, or a separate hydration step may follow extraction. For silicone hydrogel lenses, the lenses generally require a more rigorous extraction, employing an organic solvent to remove impurities such as unreacted monomers, oligomers formed as byproducts of the polymerization process and any diluent used in the lens-forming silicone monomer mixtures. Following extraction, the silicone hydrogel lenses are subjected to one or more hydration steps where the lens are contacted with water or an aqueous solution, so as to hydrate the lens and replace the organic solvent used in the prior extraction step.

Inspection is typically performed to ensure that the lens does not have any defects, such as rips or other imperfections. Inspection may be conducted manually by an operator, or with automation. Subsequently, lenses passing inspection are packaged, typically in a sealed blister package. In the case of hydrogels, the lens is packaged along with an aqueous solution so the lens remains hydrated while stored in the package. Typically, the lens and the packaging solution are sterilized by autoclaving the package and its contents.

As mentioned, various debris can accumulate on the lens during manufacture, even for automated or semi-automated manufacturing processes. For example, if any machining operations are involved with the lens manufacture, such as a lens edging, debris such as dust or polishing agent from the edging operation can adhere to the lens. Additionally, there exists environmental debris such as dust. An operator can manually clean the lens by rubbing the lens between his/her fingers, but this is labor intensive, involves higher manufacturing costs and introduces risk that the operator damages the lens. For automated inspection processes, debris on the lens can cause the inspection system to register a “false-positive” defect, as the debris is mistaken by the system as a defect, thus resulting in reduced yields and higher manufacturing costs.

The present invention solves this problem by removing debris from the lens prior to inspection.

The solutions employed in this invention are aqueous solutions. The compositions include, as an essential component, a surfactant to remove debris from the lens. It is believed the debris that accumulates on lenses during manufacturing have a weak chemical or physical interaction with the lens surface that results in the debris adhering the lens, for example, the contaminants from the manufacturing operation adhere by Van der Waals forces and/or static charge. This is distinguished from proteins or lipids that bind to a worn contact lens. The surfactant must be able to remove such manufacturing debris, preferably without manual rubbing of the lens by an operator.

Preferred surfactants are nonionic, water-soluble surfactants. Generally, the surfactants will have a hydrophilic-lipophilic balance (HLB) in the range of 10 to 35 and a molecular weight in the range of 400 to 20,000.

One class of preferred surfactants are block copolymers of ethyleneoxide and propyleneoxide, where the ratio of polyoxyethylene and polyoxypropylene repeating units determines the hydrophilic-lipophilic balance (HLB) of the surfactant. As a first example, poloxamers are polyoxyethylene, polyoxypropylene block polymers available under the tradename Pluronic (BASF Wyandotte Corp., Wyandotte, Mich.). Specific poloxamers include poloxamer 407 (available as Pluronic F-127) and poloxamer 108 (available as Pluronic F-38). An additional example is meroxapol 105 (available as Pluronic 10 R5). As a second example, poloxamines are ethylene diamine adducts of such polyoxyethylene, polyoxypropylene block polymers available under the tradename Tetronic (BASF Wyandotte Corp.). Specific poloxamines include poloxamine 1107 (available as Tetronic 1107) having a molecular weight from about 7,500 to about 27,000 wherein at least 40 weight percent of said adduct is poly(oxyethylene), and poloxamine 1304 (available as Tetronic 1304).

Another class of surfactants are various polyethylene glycol ethers of stearyl alcohol. A specific example is steareth-100, available under the tradename Brij 700 (ICI Americas).

Other non-ionic surfactants include: polyethylene glycol esters of fatty acids, e.g. coconut, polysorbate, polyoxyethylene or polyoxypropylene ethers of higher alkanes (C₁₂-C₁₈); polysorbate 20 (available under the trademark Tween® 20); polyoxyethylene (23) lauryl ether (available under the tradename Brij® 35); polyoxyethyeneglycol (40) stearate (available under the tradename Myrj® 52); polyoxyethyeneglycol (20) stearate (available under the tradename Myrj® 49); and polyoxyethylene (25) propylene glycol stearate (available under the tradename Atlas® G 2612).

Various other surfactants suitable for in the invention can be readily ascertained, in view of the foregoing description, from McCutcheon's Detergents and Emulsifiers, North American Edition, McCutcheon Division, MC Publishing Co., Glen Rock, N.J. 07452 and the CTFA International Cosmetic Ingredient Handbook, Published by The Cosmetic, Toiletry, and Fragrance Association, Washington, D.C.

Preferably, the surfactants are employed in a total amount from about 0.01 to about 15 weight percent, preferably 0.1 to 5.0 weight percent, and most preferably 0.1 to 1.5 weight percent.

Optionally, the solutions may include a buffering agent, which is useful for maintaining a desired pH value of the solutions. Generally, a pH value between about 6 to about 8, and more preferably between 6.8 to 7.5, is preferred. Suitable buffers include: borate buffers, based on boric acid and/or sodium borate; phosphate buffers, based on, Na₂HPO₄, NaH₂PO₄ and/or KH₂PO₄; a citrate buffer, based on potassium citrate and/or citric acid; sodium bicarbonate; tromethamine; and combinations thereof. Generally, buffering agents, if present, will be used in amounts ranging from about 0.05 to 2.5 weight percent, and preferably, from 0.1 to 1.5 weight percent.

Optionally, the solutions may include an antimicrobial agent. Antimicrobial agents are employed in various contact lens care solutions used by contact lens wearers to disinfect their lenses while not worn. In the solutions employed in this invention, disinfection of lenses is not required. However, if desired, an antimicrobial agent may be employed to prevent microbial growth in solution while stored in the manufacturing process. Suitable antimicrobial agents include: poly[(dimethyliminio)-2-butene-1,4-diyl chloride] and [4-tris(2-hydroxyethyl)ammonio]-2-butenyl-w-[tris(2-hydroxyethyl)ammonio]dichloride (chemical registry no. 75345-27-6) generally available as Polyquaternium 1 (ONYX Corporation); biguanides and their salts, such as alexidine and polyhexamethylene biguanides (such as PHMB available form ICI Americas, Inc., Wilmington Del. under the tradename Cosmocil CQ); benzalkonium chloride (BAK); and sorbic acid. If present, the antimicrobial agent is employed in an amount effective to preserve the solution and prevent microbial growth.

The compositions may contain various other components including a chelating and/or sequestering agent and an osmolality adjusting agent. Chelating agents, also referred to as sequestering agents, are frequently employed in conjunction with an antimicrobial agent. Examples of chelating agents include ethylenediaminetetraacetic acid (EDTA) and its salts, especially disodium EDTA. Such agents, when present, may be employed in amounts from about 0.01 to about 2.0 weight percent. Other suitable sequestering agents include gluconic acid, citric acid, tartaric acid and their salts, e.g. sodium salts. Examples of osmolality adjusting agents include: sodium and potassium chloride; monosaccharides such as dextrose; calcium and magnesium chloride; and low molecular weight polyols such as glycerin and propylene glycol. These agents are used individually in amounts ranging from about 0.01 to 5 weight percent and preferably, from about 0.1 to about 2 weight percent. Sodium chloride is especially preferred.

The lenses may be contacted with the solution by dipping. As an example, multiple lenses may be held in a tray or basket, preferably including individual compartments for holding individual lenses, wherein the entire tray or basket in then dipped into a bath of the solution so that each lens is rinsed with the solution. Examples of suitable trays are described in WO 01/32408 (corresponding to U.S. Ser. No. 09/684,644, filed Oct. 10, 2000) and U.S. Provisional Application Serial No. 60/368,623, filed Mar. 28, 2002, the disclosures of which are incorporated herein by reference. If necessary, the solution bath may be agitated to effect more efficient removal of debris from the lenses. For example, the bath may be provided with a stirrer or with ultrasonic agitation.

After the debris are removed from the lenses, the lenses can then be inspected and packaged.

As an illustration of the present invention, several examples are provided below. These examples serve only to further illustrate aspects of the invention and should not be construed as limiting the invention.

### EXAMPLES 1-6

The following are representative solutions that may be employed in this invention.

TABLE 1

| Component | Ex 1 | Ex 2 | Ex 3 | Ex 4 | Ex 5 | Ex 6 |
|---|---|---|---|---|---|---|
| Boric Acid | 0.64% | 0.64% | 0.64% | 0.64% | 0.64% | 0.64% |
| Sodium Borate | 0.09% | 0.09% | 0.09% | 0.09% | 0.09% | 0.09% |
| Sodium | 0.49% | 0.49% | 0.49% | 0.49% | 0.49% | 0.49% |
| Chloride | | | | | | |
| Poloxamine | 0.5% | | | | | |
| 1107 | | | | | | |
| Meroxapol 105 | | 0.5% | | | | |
| Steareth-100 | | | 0.5% | | | |
| Tetronic 1304 | | | | 0.5% | | |
| Poloxamer 108 | | | | | 0.5% | |
| Poloxamer 407 | | | | | | 0.5% |
| Purified Water | 98.28% | 98.28% | 98.28% | 98.28% | 98.28% | 98.28% |

The following experiments were conducted to test the solutions of Examples 1-6 in Table 1. Seventy silicone hydrogel lenses were obtained from the same manufacturing lot. The lenses were cast by a static cast molding process, and subjected to extraction and hydration prior to the present experiments. The lenses are commercial silicone hydrogel contact lenses made of the copolymer balafilcon A, more fully described in U.S. Pat. No. 5,260,000 (Nandu et al.), the disclosure of which is incorporated herein by reference.

The 70 lenses were divided into 7 sublots, each containing 10 lenses. For each sublot, 100 ml of each solution of Examples 1-6 was placed into a 400-ml beaker, and 10 lenses were placed into this same beaker and allowed to soak for a duration of 10 minutes. As a control, 100 ml of a solution similar to the solutions of Examples 1-6, but lacking any surfactant, was placed into a 400-ml beaker, and 10 lenses were placed into this same beaker. After each sublot of lenses was dipped into the specific solution (Examples 1-6 and Control), the lenses were immediately transferred to individual cells containing purified water, and then transferred to an inspection station. The lenses were rated as to cleaning efficiency.

For each of the sublots dipped in the solutions of Examples 1-6, all ten lenses were sufficiently cleaned that no finger rubbing was necessary. It was observed that the lenses dipped in the solution of Example 1 was noticeably cleaner. The lenses dipped into the Control solution had dark particles adhered to them, and required finger cleaning.

TABLE 2

| Component | Ex 7A | Ex 7B | Ex 8A | Ex 8B |
|---|---|---|---|---|
| Boric Acid | 0.64% | 0.64% | 0.64% | 0.64% |
| Sodium Borate | 0.09% | 0.09% | 0.09% | 0.09% |
| Sodium Chloride | 0.49% | 0.49% | 0.49% | 0.49% |
| Poloxamine 1107 | 0.5% | 0.5% | 1.0% | 1.0% |
| Purified Water | 98.28% | 98.28% | 97.78% | 97.78% |
| Soak/Dip Time | 10 min | 20 min | 10 min | 20 min |

The following experiments were conducted using the solutions of Table 2. It is noted that the solutions of Examples 7A and 7B in Table 2 correspond to Example 1 in Table 1. Two hundred fifty silicone hydrogel contact lenses (balafilcon A) were obtained from the same manufacturing lot, the lenses having been cast by a static cast molding process and subjected to extraction and hydration prior to the present experiments. The lenses were divided into 5 sublots of 50 lenses each, one sublot being used as a Control. A tank was filled with approximately seven gallons of each solution in Table 2. Each sublot of contact lenses, containing in a tray, was dipped into the tank for the times indicated in Table 2. The tank was equipped with ultrasonic agitation but agitation was not used. After each sublot of lenses was dipped into the specific solution for the specified time (10 minutes or 20 minutes), the lenses were immediately transferred to a tank of purified water for 10 minutes, and then transferred to an inspection station. The lenses were rated as to cleaning efficiency.

For each of the sublots dipped in the solutions of Examples 7A, 7B, 8A and 8B, all lenses were sufficiently cleaned that no finger rubbing was necessary. Therefore, a ten-minute dipping time was sufficient, and a 0.5 wt % surfactant solution was sufficient. All 50 of the Control lenses required finger cleaning.

It will be appreciated that aspects of this invention are applicable for manufacture of biomedical devices beside ophthalmic lenses, such as ophthalmic implants. Accordingly, this invention also provides a method where biomedical devices are contacted with the aqueous solution comprising a surfactant to remove debris from the device, prior to inspecting and packaging the article.

Although various preferred embodiments have been illustrated, many other modifications and variations of the present invention are possible to the skilled practitioner. It is therefore understood that, within the scope of the claims, the present invention can be practiced other than as herein specifically described.

We claim:

1. A method of manufacturing an ophthalmic lens, comprising sequentially:
casting an ophthalmic lens by polymerizing a lens-forming monomer mixture in a mold, and removing the cast lens from the mold;
contacting the cast lens with an aqueous solution comprising a surfactant to remove debris from the lens; and
inspecting and packaging the lens.

2. The method of claim 1, wherein the aqueous solution further comprises a buffering agent.

3. The method of claim 2, wherein the buffering agent includes at least one member selected from the group consisting of a borate buffer, a phosphate buffers and a citrate buffer.

4. The method of claim 2, wherein the aqueous solution further comprises sodium chloride.

5. The method of claim 2, wherein the aqueous solution-further comprises a borate buffer and sodium chloride.

6. The method of claim 1, wherein the surfactant is a nonionic surfactant having a hydrophilic-lipophilic balance in the range of 10 to 35.

7. The method of claim 6, wherein the surfactant includes a polyoxyethylene-polyoxypropylene block copolymer.

8. The method of claim 7, wherein the surfactant includes a poloxamer.

9. The method of claim 7, wherein the surfactant includes a poloxamine.

10. The method of claim 1, wherein the lens is inspected manually.

11. The method of claim 1, wherein the lens is inspected with automation.

12. The method of claim 1, wherein the lens is contacted with the aqueous solution by dipping the lens is said solution.

13. The method of claim 1, wherein debris are removed from the lens without manual rubbing of the contact lens.

14. The method of claim 1, wherein the lens is a contact lens.

15. The method of claim 14, wherein the lens is a hydrogel contact lens.

16. The method of claim 15, wherein the lens is a silicone hydrogel contact lens.

17. The method of claim 1, wherein the lens is an intraocular lens.

18. A method of manufacturing a biomedical device, comprising: contacting the device with an aqueous solution comprising a surfactant to remove debris from the device; and subsequently, inspecting and packaging the article.

19. The method of claim 18, wherein the device is a hydrogel contact lens.

20. The method of claim 18, wherein the device is an ophthalmic implant.
